(19) United States
(12) Patent Application Publication
(10) Pub. No.: US 2015/0339000 A1
(43) Pub. Date: Nov. 26, 2015

(54) OPTICAL TOUCH DEVICE, CORRECTION ELEMENT, AND CORRECTION METHOD THEREFOR

(71) Applicants: Cheng-Shen LEE, Hsin-Chu (TW); Chih-Neng TSENG, Hsin-Chu (TW); Shu-Yu LIN, Hsin-Chu (TW)

(72) Inventors: Cheng-Shen LEE, Hsin-Chu (TW); Chih-Neng TSENG, Hsin-Chu (TW); Shu-Yu LIN, Hsin-Chu (TW)

(73) Assignee: Coretronic Corporation, Hsin-Chu (TW)

(21) Appl. No.: 14/626,501

(22) Filed: Feb. 19, 2015

(30) Foreign Application Priority Data
May 21, 2014 (CN) 201410216068.3

(51) Int. Cl. G06F 3/042; G06F 3/041

(52) U.S. Cl. CPC G06F 3/0428; G06F 3/0416; G06F 2203/04109

(57) ABSTRACT

An optical touch device configured to cause a display surface to from a touch surface. The optical touch device includes a non-visible lighting element, a non-visible sensing element, and a correction element. The non-visible lighting element is adjacent to the display surface and forms a non-visible light curtain in front of the display surface. The non-visible lighting element is disposed in front of the display surface and has a sensing area covering the display surface. The correction element is disposed on the display surface and includes a bottom layer placed on the display surface and a plurality of reflecting blocks disposed on the top surface of the bottom layer. The correction element of the optical touch device has long-life. A correction method for an optical touch device is also provided.

### FIELD OF THE INVENTION

The invention relates to a touch device, and more particularly to an optical touch device and a correction method and a correction element thereof.

### BACKGROUND OF THE INVENTION

Current projection equipments read infrared light signal reflected from the front of a display surface thereof by using infrared sensor, and then the current projection equipments is used as optical-touch projection equipments. An infrared light curtain is formed in front of the display surface of the projection equipment by using infrared light source. When a user touches the display through fingers, pens or other objects, the infrared light curtain touches these objects to form reflected light and then the infrared sensor senses the reflected light. A control system of the projection equipment determines a position of a touch motive corresponded to the display surface through changes of the reflected light.

Optical touch devices with infrared light source and infrared sensor are disclosed in many patent applications, such as US patent publication NO. 20110115904, China patent NO. 103064562, China patent publication NO. 103135860, China patent publication NO. 103284684, and Taiwan patent publication NO. 201117079.

While the infrared light curtain is formed in front of the display surface through the infrared light source, the infrared light curtain has to be substantially parallel to the display surface and an appropriate distance between the infrared light curtain and the display surface should be maintained; otherwise, it reduces sensitivity and accuracy of touch sensing. Therefore, while the infrared light source is set, the position of the infrared light source has to be corrected to make the infrared light curtain provided by the infrared light source to be parallel to the display surface and keep an appropriate distance between the infrared light curtain and the display surface.

However, infrared light is invisible light, so the current technique corrects the position of the infrared light source by using an infrared sensor card. The infrared sensor card uses fluorescent powder excited by the incident infrared light so the infrared light is converted to visible light. But the infrared sensor card is expensive, and the conversion efficiency is reduced during long usage time so as to result in recognizing illegibly by eyes. Therefore, the conventional design has an disadvantage of short life time. The conventional projection equipments with infrared sensor have been unable to overcome the above problems.

The information disclosed in this BACKGROUND section is only for enhancement of understanding of the BACKGROUND of the described technology and therefore it may contain information that does not form the prior art that is already known to a person of ordinary skill in the art. Further, the information disclosed in the BACKGROUND section does not mean that one or more problems to be resolved by one or more embodiments of the invention was acknowledged by a person of ordinary skill in the art.

### SUMMARY OF THE INVENTION

One aspect of the invention is to provide a correction element of an optical touch device having advantages of low cost-of-production and long life time.

Another aspect of the invention is to provide a correction method of an optical touch device having advantages of a precise position adjustment for a non-visible lighting element of the optical touch device relative to a display surface.

The invention provides an optical touch device configured to cause a display surface to form a touch surface. The optical touch device includes a non-visible lighting element, a non-visible sensing element, and a correction element. The non-visible lighting element is adjacent to the display surface and forms a non-visible light curtain on the display surface. The non-visible light curtain covers the display surface. The non-visible sensing element is adjacent to the display surface and has a sensing area covering the display surface. The correction element is disposed on the display surface and includes a bottom layer and a plurality of reflecting blocks. The bottom layer has a bottom surface, a top surface opposite to the bottom surface, and at least one side surface connected to the bottom and top surfaces. The bottom layer is disposed on the display surface. The reflecting blocks are disposed on the top surface.

In one embodiment, the correction element further includes a light-shielding element disposed on the bottom layer.

In one embodiment, the light-shielding element is disposed on the top surface and disposed among the reflecting blocks.

In one embodiment, the side surface is parallel to a length direction of the bottom layer, and the length direction is parallel to the display surface; wherein at least one light-shielding layer is disposed on the side surface and adjacent to the bottom surface.

In one embodiment, the light-shielding layer is disposed on the bottom surface of the bottom layer and disposed between the bottom layer and the display surface.

In one embodiment, at least two of the reflecting blocks have the same height on a first direction perpendicular to the display surface.

In one embodiment, the reflecting blocks have different heights on a first direction perpendicular to the display surface.

In one embodiment, the reflecting blocks include a first reflecting block, a second reflecting block, and a third reflecting block. The first reflecting block has a first height on the first direction perpendicular to the display surface, the second reflecting block has a second height on the first direction perpendicular to the display surface, and the third reflecting block has a third height on the first direction perpendicular to the display surface. The first height is larger than the second height, and the second height is larger than the third height.

In one embodiment, the correction element further includes two light-shielding elements disposed on the top surface, and respectively placed between the first and third reflecting blocks and between the second and third reflecting blocks. The light-shielding elements have the same height on the first direction perpendicular to the display surface as the third height.

In one embodiment, the at least one of the reflecting blocks has a stepped structure gradually rising or falling along a second direction parallel to the display surface.

In one embodiment, the optical touch device further includes a projection equipment configured to project an image to the display surface.

In one embodiment, the non-visible sensing element is connected to the projection equipment.

The invention further provides a correction element of an optical touch device. The correction element is configured to correct a relative position between a non-visible lighting element of the optical touch device and a display surface. The correction element includes a bottom layer and a plurality of reflecting blocks. The bottom layer is disposed on the display surface and having a bottom surface, a top surface opposite to the bottom surface, and at least one side surface connected to the bottom and top surfaces. The reflecting blocks is disposed on the top surface.

The invention further provides a correction method of an optical touch device for correcting a relative position between a non-visible lighting element of the optical touch device and a display surface. The correction method of the optical touch device includes steps of:

at least one correction element on the display surface is set; wherein the correction element includes a bottom layer and a plurality of reflecting blocks, the bottom layer is disposed on the display surface, and the reflecting blocks are disposed one a top surface of the bottom layer;

the non-visible lighting element is driven to form a non-visible light curtain covering the display surface; and

a pattern on the non-visible light curtain after a reflection of the correction element by a non-visible sensing element is sensed.

In summary, the correction element of the embodiment of the invention disposed in front of the display surface is configured to reflect part of light of the non-visible light curtain to the non-visible sensing element, and it may be determine that whether the non-visible light curtain is parallel to the display surface and an appropriate distance between the non-visible light curtain and the display surface is maintained according to a pattern sensed by the non-visible sensing element. Comparing to an infrared sensor card used in the current projection equipment, the cost-of-production of the correction element of the embodiment of the invention is low and the correction element has long life time. Therefore, an optical touch device and a correction method using the correction element of the embodiment of the invention have advantages of low cost-of-production and long life time.

Other objectives, features and advantages of the present invention will be further understood from the further technological features disclosed by the embodiments of the present invention wherein there are shown and described preferred embodiments of this invention, simply by way of illustration of modes best suited to carry out the invention.

In order to make the aforementioned and other features and advantages of the invention comprehensible, a plurality of embodiments accompanied with figures are described in detail below.

### BRIEF DESCRIPTION OF THE DRAWINGS

FIG. 1 is a schematic diagram of an optical touch device according to a embodiment of the invention;

FIG. 2 is a schematic diagram of a correction element according to an embodiment of the invention;

FIG. 3 is a flow chart of a correction method of the optical touch device according to an embodiment of the invention;

FIG. 4A is a schematic diagram of correction of the optical touch device according to an embodiment of the invention;

FIG. 4B is another schematic diagram of correction of the optical touch device according to an embodiment of the invention;

FIG. 5A is a schematic diagram of a non-visible light curtain parallel to a display surface according to an embodiment of the invention;

FIG. 5B is a schematic diagram of light shapes sensed by a non-visible sensing element according to an embodiment of the invention;

FIG. 5C is a schematic diagram of the non-visible light curtain non-parallel to the display surface element according to an embodiment of the invention;

FIG. 5D is another schematic diagram of light shapes sensed by the non-visible sensing element according to an embodiment of the invention;

FIG. 6 is a schematic diagram of a correction element according to another embodiment of the invention;

FIG. 7 is a schematic diagram of a correction element according to another embodiment of the invention;

FIG. 8 is a schematic diagram of a correction element according to another embodiment of the invention.

### DETAILED DESCRIPTION OF PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

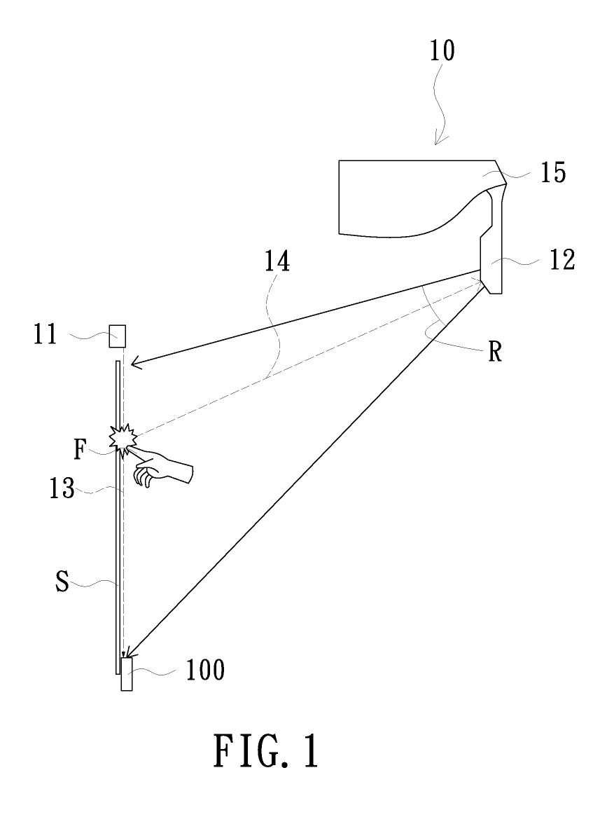

Please refer to FIG. 1. An optical touch device 10 of the embodiment of the invention is configured to cause a display surface to form a touch surface and convert general display equipment into electronic touch equipment. The optical touch device 10 includes a non-visible lighting element 11, a non-visible sensing element 12, and at least one correction element 100. The non-visible lighting element 11 is disposed near a display surface S and forms a non-visible light curtain 13 on the display surface S to cover display surface S. The non-visible sensing element 12 is disposed near to the display surface S and has a sensing area R covering the display surface S.

A light source used by the non-visible lighting element 11 may be infrared light source, and the non-visible sensing element 12 is configured to sense the light (i.e. infrared light) provided by the non-visible lighting element 11. However, the non-visible lighting element in the invention is not limited to the infrared lighting element. The display surface S may be white board, wall, curtain or other plates capable of reflecting light. The optical touch device 10 may further include a projection equipment 15 placed in front of the display surface S. The projection equipment 15 projects an image to the display surface S. In the embodiment, the non-visible sensing element 12 may be connected to the projection equipment 15; however the invention is not limited to the requirement for the connection of non-visible sensing element and the projection equipment.

When the display surface S is touched by using user's finger F (or pens or other objects), part of light (like light 14) of the non-visible light curtain 13 will be reflected by the finger F and then received by the non-visible sensing element 12. The non-visible sensing element 12 may determine a relative position between the finger F and the display surface S (a position of the finger F relative to the display surface S) according to a position of the received light 14. And then the user's touch action may be known.

However, in order to ensure the touch sensing sensitivity and accuracy, the correcting action is required when settling the non-visible lighting element 11 is completed, and the non-visible light curtain 13 may be parallel to the display surface S to maintain an appropriate distance between the non-visible light curtain 13 and the display surface S. The correction element 100 is configured to be placed to the display surface S for correcting the position of the non-visible lighting element 11 and an emitting angle of the light 14 relative to the display surface S.

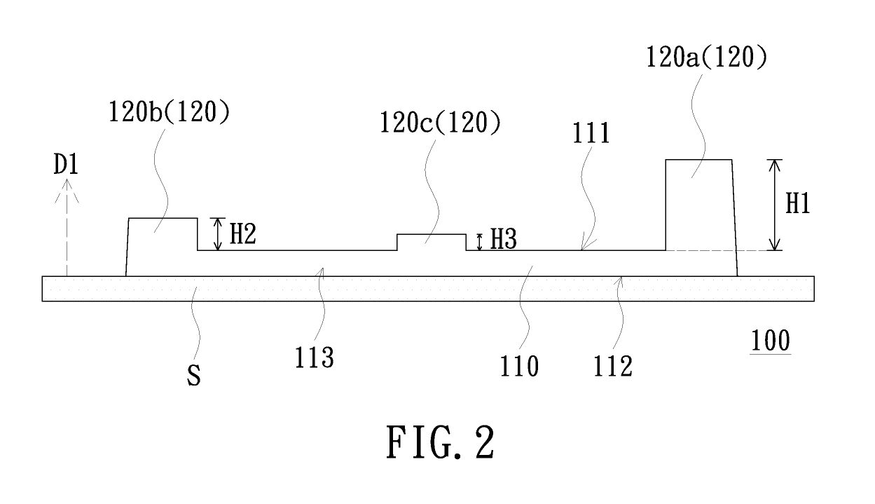

Please refer to FIGS. 1 and 2. The correction element 100 includes a bottom layer 110 and a plurality of reflecting blocks 120. The bottom layer 110 is disposed on the display surface S and has a bottom surface 112, a top surface 111 opposite to the bottom surface 112, and at least one side surface 113 connected to the bottom surface 112 and the top surface 111. The reflecting blocks 120 are disposed on the top surface 111. Both of the bottom surface 112 and the top surface 111 are, for example, parallel to the display surface S.

Materials of the bottom layer 110 and the reflecting blocks 120 have high reflectance characteristics relative to the non-visible light provided by the non-visible lighting element 11; therefore, the non-visible light reflected to the non-visible sensing element 12 would be beneficial. The material(s) having high reflectance characteristics may be foam, however the invention is not limited thereto. Colors of the bottom layer 110 and the reflecting blocks 120 may be white or light color(s) for a benefit to the reflection of the non-visible light. Material of the bottom layer 110 may be the same as material of the reflecting blocks 120, or may be different from material of the reflecting blocks 120. Moreover, the bottom layer 110 and the reflecting blocks 120 may be an integrated structure.

At least two of the reflecting blocks 120 may have the same height on a first direction D1 perpendicular to the display surface S. However, each reflecting block 120 may have different height from one another. In the embodiment of the invention, the reflecting blocks 120 includes, for example, a first reflecting block 120a having a first height H1, a second reflecting block 120b having a second height H2, and a third reflecting block 120c having a third height H3. The third reflecting block 120c is disposed between the first reflecting block 120a and the second reflecting block 120b. The first height H1 is larger than the second height H2. The second height H2 is larger than the third height H3. Moreover, the first reflecting block 120a and the second reflecting block 120b are respectively disposed on two sides of the top surface 111. The third reflecting block 120c is, for example, disposed on the center of the top surface 111.

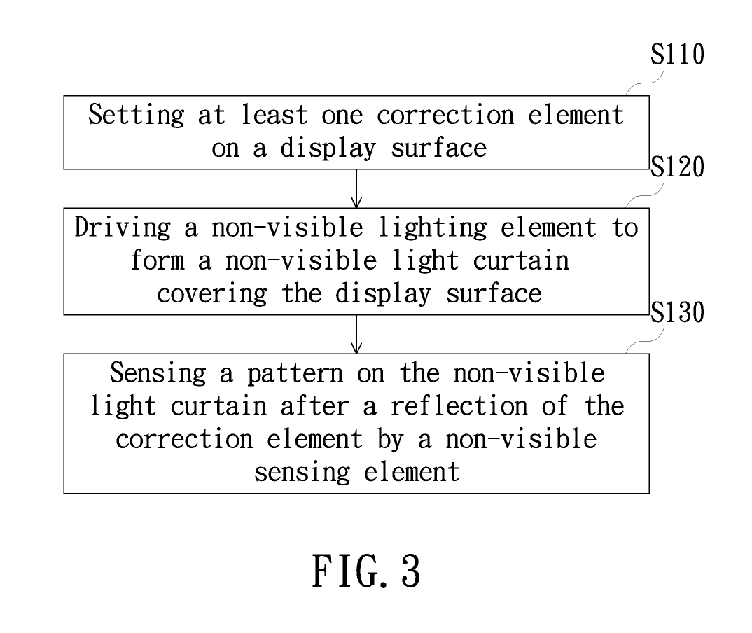

The correction by using the correction element 100 and the non-visible lighting element 11 is described in the following description. Please refer to FIGS. 1, 3 and 4A. The non-visible lighting element 11 includes, for example, two non-visible light sources 16 and 17. The emitting light angle C1 from the non-visible light source 16 may cover a part of the display surface S. The emitting light angle C2 from the non-visible light source 17 may also cover a part of the display surface S. The non-visible light sources 16 and 17 form the non-visible light curtain 13.

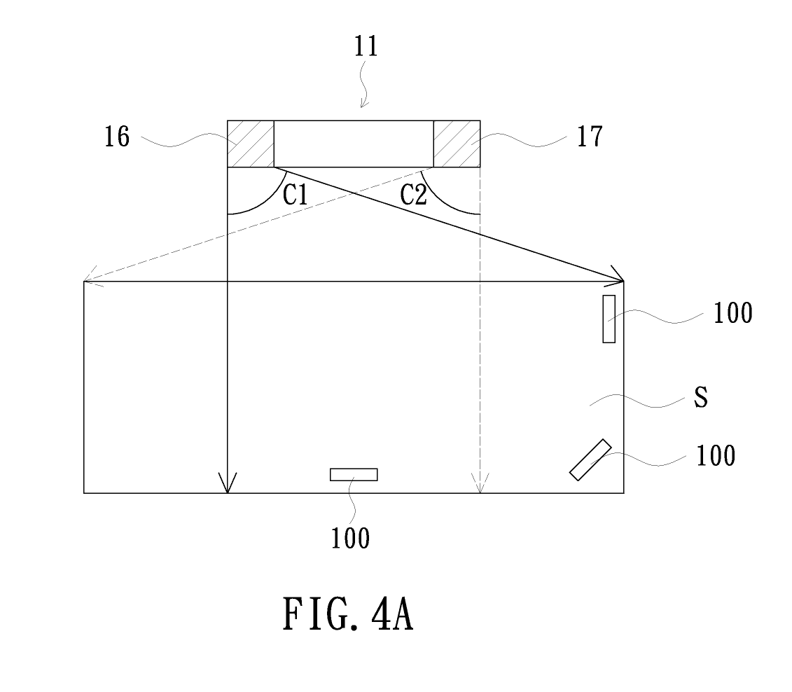

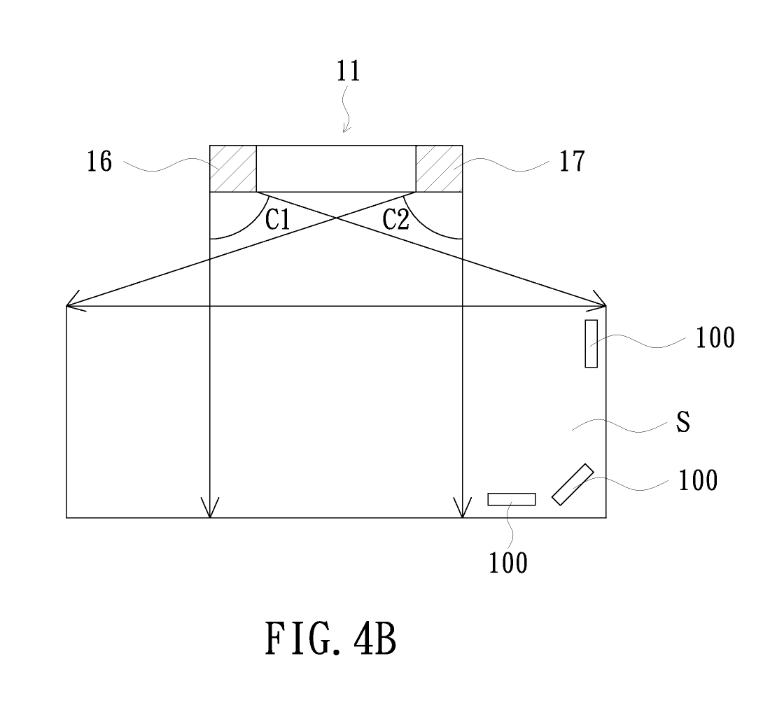

According to the above descriptions, a correction method of the optical touch device 10, for example, includes the following steps. Firstly, as shown in step S110, at least one correction element 100 is set to be disposed on the display surface S. To be more specific, as shown in FIG. 4A, while the position of the non-visible light sources 16 is corrected, three correction elements 100 may be used respectively to be disposed on the center of the lower side, the lower right corner, and the upper right corner of the display surface S. However, only one correction element 100 may be used to be disposed on the above-mentioned positions of the display surface S in order. The invention is not limited to the numbers and the positions of the correction elements 100. Similarly, while the position of the non-visible light sources 17 is corrected, three correction elements 100 may be used respectively to be disposed on the center of the lower side, the lower left corner, and the upper left corner of the display surface S.

Then, as shown in step S120, the non-visible lighting element is driven to form the non-visible light curtain 13 on the display surface S for covering the display surface S. For example, the optical touch device 10 has, for example, a correction mode. While the correction mode is actuated, the non-visible light sources 16 and 17 may be driven to light at the same time or only one of the non-visible light sources 16 and 17 may be driven to light. In another embodiment, the non-visible light sources 16 and 17 may be driven to turn on/off by a physical/practical switch. While the non-visible light sources 16 and 17 light are driven at the same time, the correction element(s) 100 placed on the center of the lower side of the display surface S would be moved to leave the emitting overlap area to avoid influencing the correction result. For example, as shown in FIG. 4B, while the position of the non-visible light source 16 is corrected, the correction element(s) 100 placed on the lower side of the display surface S would be moved to the lower right corner of the display surface S to avoid the emitting overlap area of the non-visible light sources 16 and 17. Similarly, while the position of the non-visible light source 17 is corrected, the correction element(s) placed on the lower side of the display surface S would be moved to the lower left corner of the display surface S to avoid the emitting overlap area of the non-visible light sources 16 and 17.

Afterwards, as shown in S130, a pattern on the non-visible light curtain after a reflection of the at least one correction element is sensed through a non-visible sensing element. Because of shape of the correction elements 100 is in particular design, the pattern mentioned above may be used to determine whether the non-visible light curtain 13 is parallel to the display surface S or not and whether an appropriate distance between the non-visible light curtain 13 and the display surface S is maintained or not. In the correction mode, the projection equipment 15 may project the pattern sensed above to the display surface S or to be displayed by a computer (not shown in the drawings) connected to the projection equipment 15, so that the user may adjust the position of the non-visible light sources 16 and 17 accordingly. Or the projection equipment 15 may determine how to adjust the position of the non-visible light sources 16 and 17 according to the pattern sensed above so as to project to the display surface S or to display by the computer (not shown in the drawings) connected to the projection equipment 15 directly through a proposed adjustment.

Determining whether the non-visible light curtain 13 is parallel to the display surface S or not and whether an appropriate distance between the non-visible light curtain 13 and the display surface S is maintained or not is described in the following description.

Please refer to FIGS. 1, 2 and 5A. In the embodiment, the thickness of the bottom layer 110 is, for example, 2 mm. The first height H1 is, for example, 15 mm. The second height H2 is, for example, 10 mm. The third height H3 is, for example, 5 mm. However, the invention is not limited thereto.

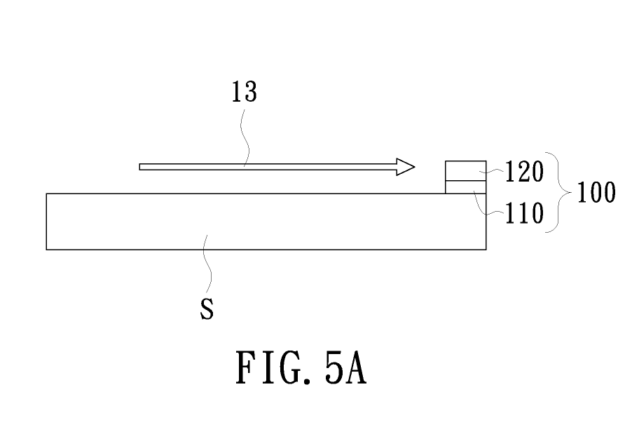

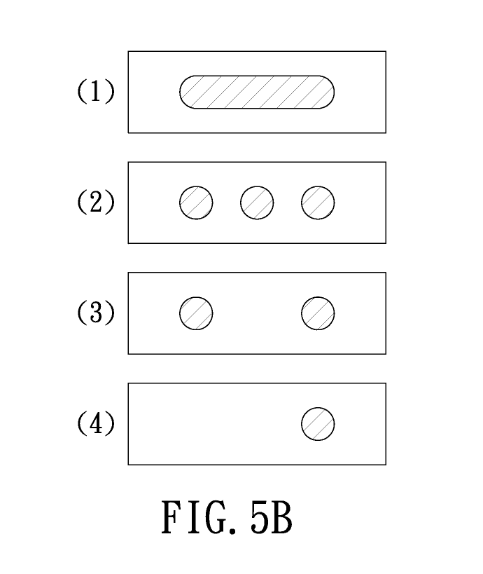

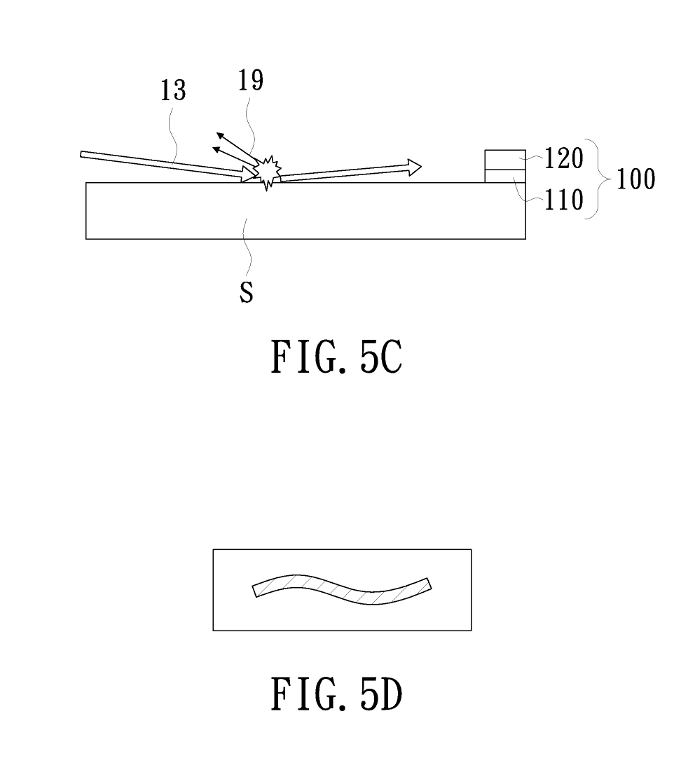

Due to the bottom layer 110 is long-strip-shaped, while the non-visible sensing element 12 senses a pattern with long-strip-shaped bright line reflected by the bottom layer 110 from the non-visible light curtain 13 (as shown in FIG. 5B(1)), the distance between the non-visible light curtain 13 and the display surface S is less than or equal to 2 mm; while the non-visible sensing element 12 senses a pattern having three bright spots reflected by the first, second, and third reflecting blocks 120a, 120b, and 120c from the non-visible light curtain 13 (as shown in FIG. 5B(2)), the distance between the non-visible light curtain 13 and the display surface S is between 2 mm to 7 mm: while the non-visible sensing element 12 senses a pattern having two bright spots reflected by the first and second reflecting blocks 120a and 120b from the non-visible light curtain 13 (as shown in FIG. 5B(3)), the distance between the non-visible light curtain 13 and the display surface S is between 7 mm to 12 mm; while the non-visible sensing element 12 senses a pattern having one bright spot reflected by the first reflecting block 120a from the non-visible light curtain 13 (as shown in FIG. 5B(4)), the distance between the non-visible light curtain 13 and the display surface S is between 12 mm to 17 mm; while the non-visible sensing element 12 does not sense the pattern with clear bright line or bright spot, the distance between the non-visible light curtain 13 and the display surface S may be over 17 mm.

It may be designed that the distance between the non-visible light curtain 13 and the display surface S is too close while the non-visible sensing element 12 senses the long-strip-shaped bright image, that the distance between the non-visible light curtain 13 and the display surface S is appropriate while the non-visible sensing element 12 senses a pattern with three bright spots, or that the distance between the non-visible light curtain 13 and the display surface S is too far while the non-visible sensing element 12 senses a pattern with a bright spot or two bright spots. However, the invention is not limited thereto.

Please refer to FIGS. 1, 2 and 5C. While the non-visible light curtain 13 is not parallel to the display surface S, parts of light 19 of the non-visible light curtain 13 would be reflected by the display surface S to the non-visible sensing element 12. And at this time, the non-visible sensing element 12 would sense an irregular bright line (as shown in FIG. 5D). According to position and shape of the irregular bright line, it may be determined that the pattern/image with irregular bright line is not reflected by the correction elements 100 from the non-visible light curtain 13, so as to determine that the non-visible light curtain 13 is not parallel to the display surface S.

In the embodiment of the invention, the correction element(s) 100 placed in front of the display surface S may reflect parts of light of the non-visible light curtain 13 to the non-visible sensing element 12, and may determine whether the non-visible light curtain 13 is parallel to the display surface S or not and whether an appropriate distance between the non-visible light curtain 13 and the display surface S is maintained or not according to the pattern sensed by the non-visible sensing element 12. Comparing to an infrared sensor card used in the current projection equipment, the cost-of-production of the correction element 110 of the embodiment is lower and the correction element may have long life time due to the problem about decay of phosphor wheel being not existed.

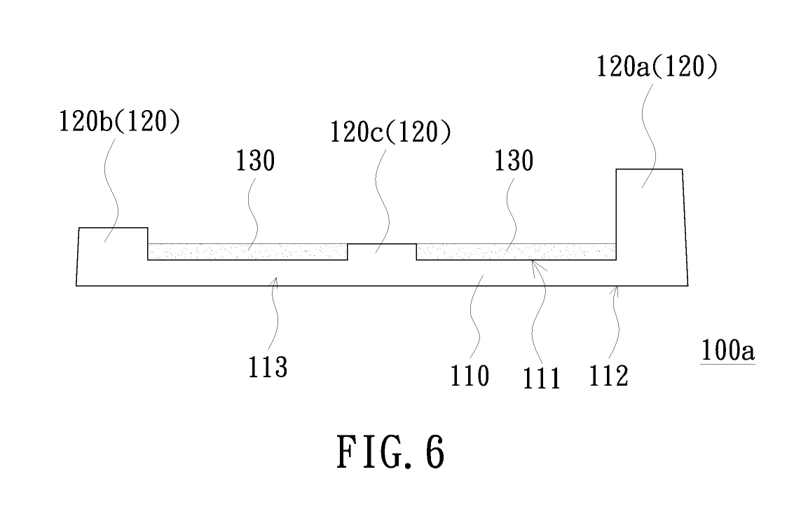

Please refer to FIG. 6. The correction element 100a shown in FIG. 6 is similar to the correction element 100 shown in FIG. 2, and the major difference is: The correction element 100a further includes two light-shielding elements 130 placed on the top surface 111 of the bottom layer 110 and respectively disposed between the first reflecting block 120a and the third reflecting block 120c and between the second reflecting block 120b and the third reflecting block 120c (one light-shielding element 130 is placed between the first and third reflecting blocks 120a, 120c, and another light-shielding element 130 is placed between the second and third reflecting blocks 120b, 120c); the height of the light-shielding elements 130 is, for example, equal to the height of the third reflecting block 120c. The light-shielding elements 130 may be black tape; however the invention is not limited to the categories of the light-shielding elements, and the light-shielding elements may be an substance capable of absorbing or shielding the non-visible light provided by the non-visible light source(s) mentioned above to avoid or decrease the reflection of the non-visible light. Because the correction element 100a in the embodiment further includes the light-shielding elements 130, the non-visible light reflection may be prevented or reduced to improve the accuracy of the correction.

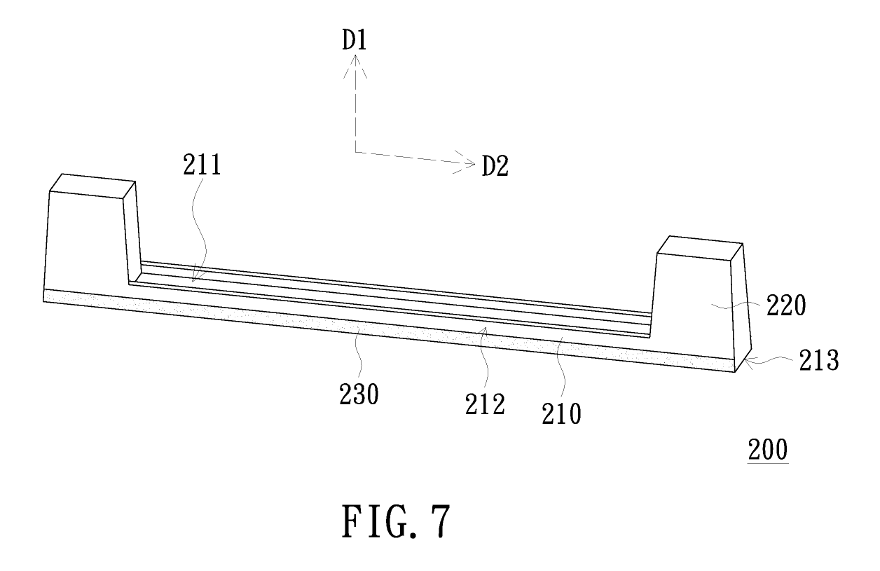

Please refer to FIG. 7. The correction element 200 shown in FIG. 7 is similar to the correction element 100 shown in FIG. 2, and the major difference is: The correction element 200 includes two reflecting blocks 220 respectively placed on two sides of the top surface 211 of the bottom layer 210 and having the same height. Moreover, the bottom layer 210 further includes at least one side surface 212 connected to the top surface 211, and the side surface 212 is parallel to a length direction D2 of the bottom layer 210. The length direction D2 is, for example, parallel to the display surface S. A light-shielding layer 230 is placed to the side surface 212 and adjacent to the bottom surface 213. The light-shielding layer 230 may be black tape or other proper objects with deep color for light absorption adhered to side surface 212; however the invention is not limited thereto.

During correction by the correction element 200, if the distance between the non-visible light curtain 13 and the display surface S is too close, the light of the non-visible light curtain 13 would be irradiated to the light-shielding layer 230 and the non-visible sensing element 12 would not sense the light or would merely sense the light weak light; if the distance between the non-visible light curtain 13 and the display surface S is appropriate, the light of the non-visible light curtain 13 would be irradiated to the bottom layer 210 and the non-visible sensing element 12 may sense a pattern with long-strip-shaped bright line; if the distance between the non-visible light curtain and the display surface S is too far, the two reflecting blocks 220 would be irradiated by the non-visible light curtain 13 and the non-visible sensing element 12 may sense a pattern with two bright spots.

In another embodiment, the light-shielding layer 230 may be disposed on the bottom surface 213 and between the bottom layer 210 and the display surface S, and may not be adhered to the side surface 212 of the bottom layer 210, wherein the light-shielding layer 230 has an appropriate thickness. In the other embodiment, the light-shielding element 130 (similar to the correction element 100a as shown in FIG. 6) may be disposed on the top surface 211 of the bottom layer 210. The light-shielding element 130 is disposed between the two reflecting blocks 220, and the non-visible light reflection may be prevented or reduced to improve the accuracy of the correction.

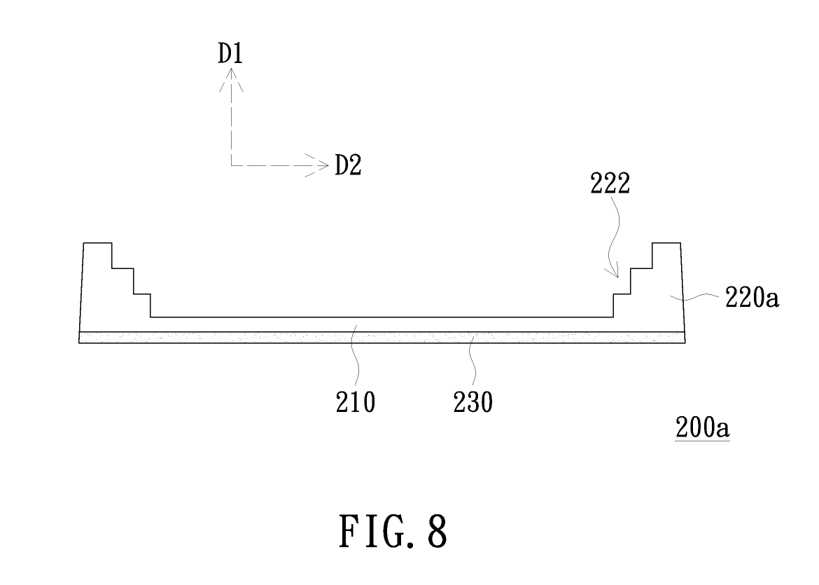

Please refer to FIG. 8. The correction element 200a shown in FIG. 8 is similar to the correction element 200 shown in FIG. 7, and the major difference is: At least one of the reflecting blocks 220a of the correction element 200a further includes a stepped structure 222. The stepped structure 222 is formed to be gradually rising or falling along the length direction D2 of the bottom layer 210. It may be determined that how far is the distance between the non-visible light curtain 13 and the display surface S by the width of the two-bright spots pattern or the distance between the two-bright-spots pattern sensed by the non-visible sensing element 12. Both two reflecting blocks 220a shown in FIG. 8 include the stepped structure 222 and are in mirror symmetry. The width and height of steps of each stepped structure 222 may be different from each other; however the invention is not limited thereto.

In summary, comparing to the current technique using infrared sensor card, a correction element of the embodiment of the invention has advantages of low cost-of-production and long life time due to the problem about decay of phosphor wheel being not existed. Therefore, an optical touch device and a correction method using the correction element of the embodiment of the invention have advantages of low cost-of-production and long life time.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An optical touch device, configured to cause a display surface to form a touch surface, the optical touch device comprising:
a non-visible lighting element, disposed near the display surface, and forming a non-visible light curtain covering the display surface;
a non-visible sensing element, disposed near the display surface, and having a sensing area covering the display surface; and
a correction element, disposed on the display surface, and the correction element comprising:
a bottom layer, disposed on the display surface, and having a bottom surface, a top surface opposite to the bottom surface, and at least one side surface connected to the bottom surface and the top surface; and
a plurality of reflecting blocks, disposed on the top surface.

2. The optical touch device according to claim 1, wherein the correction element further comprises a light-shielding element disposed on the bottom layer.

3. The optical touch device according to claim 2, wherein the light-shielding element is disposed on the top surface and disposed among the reflecting blocks.

4. The optical touch device according to claim 2, wherein the side surface is parallel to a length direction of the bottom layer, and the length direction is parallel to the display surface, wherein at least one light-shielding layer is disposed on the side surface and adjacent to the bottom surface.

5. The optical touch device according to claim 2, wherein the light-shielding layer is disposed on the bottom surface of the bottom layer and disposed between the bottom layer and the display surface.

6. The optical touch device according to claim 1, wherein at least two of the reflecting blocks have the same height on a first direction perpendicular to the display surface.

7. The optical touch device according to claim 1, wherein the reflecting blocks have different heights on a first direction perpendicular to the display surface.

8. The optical touch device according to claim 7, wherein the reflecting blocks comprise:
a first reflecting block, having a first height on the first direction perpendicular to the display surface,
a second reflecting block, having a second height on the first direction perpendicular to the display surface; and
a third reflecting block, disposed between the first reflecting block and the second reflecting block, having a third height on the first direction perpendicular to the display surface, wherein the first height is larger than the second height, and the second height is larger than the third height.

9. The optical touch device according to claim 8, wherein the correction element further comprises:
two light-shielding elements, disposed on the top surface, and respectively disposed between the first reflecting block and the third reflecting block and between the second reflecting block and the third reflecting block, wherein the light-shielding elements have the same height on the first direction perpendicular to the display surface as the third height.

10. The optical touch device according to claim 1, wherein at least one of the reflecting blocks has a stepped structure gradually rising or falling along a second direction parallel to the display surface.

11. The optical touch device according to claim 1, further comprising:
a projection equipment, configured to project an image to the display surface.

12. The optical touch device according to claim 11, wherein the non-visible sensing element is connected to the projection equipment.

13. A correction element of an optical touch device, configured to correct a relative position between a non-visible lighting element of the optical touch device and a display surface, the correction element comprising:
a bottom layer, disposed on the display surface, and having a bottom surface, a top surface opposite to the bottom surface, and at least one side surface connected to the bottom surface and the top surface; and
a plurality of reflecting blocks, disposed on the top surface.

14. A correction method of an optical touch device, for correcting a relative position between a non-visible lighting element of the optical touch device and a display surface, the correction method of the optical touch device comprising:
setting at least one correction element on the display surface, wherein the correction element comprises a bottom layer and a plurality of reflecting blocks, the bottom layer is disposed on the display surface, and the reflecting blocks are disposed on a top surface of the bottom layer;
driving the non-visible lighting element to form a non-visible light curtain covering the display surface; and
sensing a pattern on the non-visible light curtain after a reflection of the correction element by a non-visible sensing element.
